(19) United States
(12) Patent Application Publication
(10) Pub. No.: US 2025/0128279 A1
(43) Pub. Date: Apr. 24, 2025

(54) Water atomizing cup

(71) Applicant: Shenzhen Realmark Trade Co, Ltd., Shenzhen (CN)

(72) Inventor: Junlin Qin, Shenzhen (CN)

(21) Appl. No.: 19/006,394

(22) Filed: Dec. 31, 2024

(51) Int. Cl. B05B 11/10; B05B 1/16; B65D 41/04

(52) U.S. Cl. CPC B05B 11/1011; B05B 1/16; B65D 41/04

(57) ABSTRACT

Disclosed is a water atomizing cup, belonging to the technical field of cups. The water atomizing cup includes a cup lid and a cup body, the cup lid includes a lid body, a water pump is disposed in the lid body, an atomization nozzle is mounted on an atomization seat that is at a top of the water pump, one end of the water pump communicates with the atomization nozzle through the atomization seat, a water supply ring is disposed at a bottom of the lid body, and the other end of the water pump is in butt joint communication with the water supply ring through a water supply base. In the present disclosure, both ends of the water pump communicate with the water supply ring and the atomization nozzle, respectively, to improve the flexibility and the atomization effect of the cup body.

### TECHNICAL FIELD

The present disclosure belongs to the technical field of cups, and in particular, to a water atomizing cup.

### BACKGROUND

A water atomizing cup is an innovative drinking utensil that combines the modern technology with the humanized design. By using the advanced atomization technology, the atomized water cup converts liquid water into fine water mist, which can not only be directly inhaled or drank by users, but also can play a role in cooling by spraying water, moistening the air, and moisturizing the skin, etc. This drinking method is not only convenient and efficient, but also brings a new drinking experience. Therefore, it is gradually favored by the majority of users, and especially in sports and fitness, outdoor adventures and other occasions that require frequent replenishment of water, the water atomizing cup has become an indispensable utensil.

Most of the existing water atomizing cups use the method of directly inserting a straw of a water pump into a cup body, and then pumping water to an atomizer for being atomized through the water pump. This design not only limits the flexibility of the cup body, but also may affect the atomization effect due to wear or blockage of the straw during long-term use.

Therefore, the inventor is committed to designing a water atomizing cup to solve the above-mentioned problem.

### SUMMARY

An objective of the present disclosure is to provide a water atomizing cup, which has the function of atomizing drinking water without a straw, thus not only improving the flexibility of a cup body, but also addressing the problem of reduced atomization effect caused by wear or blockage of the straw.

To achieve the above-mentioned objective, a technical solution used by the present disclosure is:

A water atomizing cup, including a cup lid and a cup body, where the cup lid is covered on the cup body, the cup lid includes a lid body, a water pump is disposed in the lid body, an atomization seat is disposed at a top of the water pump, an atomization nozzle is mounted on the atomization seat, a water outlet tap of the water pump communicates with the atomization nozzle through the atomization seat, a water supply seat is disposed on a side of the water pump, a bottom of the lid body is hermetically connected with a water supply ring, a water supply hole in which water in the cup body enters is disposed on the water supply ring, a water inlet tap of the water pump is in butt joint communication with the water supply hole through the water supply seat, a lid shell is covered outside the lid body, the atomization seat and the water supply seat jointly, and a spraying portion of the atomization nozzle is exposed on the lid shell.

As an improvement of the water atomizing cup in the present disclosure, the water supply ring includes a water supply loop and a sealing ring, the water supply loop is positioned in a limiting slot on the top of the sealing ring, and an upper hole of the water supply loop is in coaxial and but joint communication with a lower hole of the sealing ring to form the water supply hole.

As an improvement of the water atomizing cup in the present disclosure, a circle of upper water supply tank is disposed at a top of the water supply loop, the upper hole is positioned in the upper water supply tank, a circle of lower water supply tank is disposed at a bottom of the sealing ring, the lower hole is positioned in the lower water supply tank, cross sections of both the water supply loop and the limiting slot are T-shaped and cooperate with each other, and a bottom of the water supply loop cooperates with a bottom of the limiting slot through a concave-convex limiting structure.

As an improvement of the water atomizing cup in the present disclosure, water outlet holes are disposed at a top of the cup body, the water supply hole communicates with the water outlet holes, an inner container of the cup body is spaced apart from an outer shell to form a negative pressure space, water inlet holes are disposed at a bottom of the inner container, and the water inlet holes communicate with the water outlet holes through the negative pressure space.

As an improvement of the water atomizing cup in the present disclosure, the lid body includes a housing and a lid seat, the water pump is mounted on the lid seat, the housing is sleeved outside the water pump and superimposed on the lid seat, and the water supply seat is positioned on the lid seat.

As an improvement of the water atomizing cup in the present disclosure, a water supply channel is disposed in the water supply seat, a connecting pipe is disposed on a top surface of the lid seat, the connecting pipe is inserted into an entry end of the water supply channel and is in coaxial communication with the water supply hole, and a filtering cotton plug is disposed in the connecting pipe.

As an improvement of the water atomizing cup in the present disclosure, a top post is disposed in the entry end of the water supply channel, the top post is inserted into the connecting pipe and forms a gap with an inner wall of the connecting pipe, and the filtering cotton plug is positioned between the top post and the water supply ring.

As an improvement of the water atomizing cup in the present disclosure, a drinking hole is disposed in the lid body, a drinking pipe is integrally disposed in the lid shell, a drinking spout on a top of the lid shell communicates with the cup body through the drinking pipe and the drinking hole in sequence, a drinking lid is hermetically covered on the drinking spout, the drinking lid is connected with a side of the lid shell through a handle, and an air inlet valve is disposed on a side wall of the drinking pipe.

As an improvement of the water atomizing cup in the present disclosure, a connecting portion at a lower end of the handle is inserted into the lid body and the lid shell and rotationally connected with the lid body, the air inlet valve is inserted onto an end face of the connecting portion, an air inlet hole is disposed on a side wall of the connecting portion, and the air inlet hole communicates with an interior of the air inlet valve.

As an improvement of the water atomizing cup in the present disclosure, a plurality of positioning grooves and a socket into which the connecting portion of the handle is inserted are disposed on a side wall of the lid shell, all of the positioning grooves are disposed at intervals in a circle around the socket, a rotating end surface of the handle is provided with a plurality of positioning protrusions around the connecting portion, and all of the positioning protrusions cooperate with some of the positioning grooves.

Compared with the existing technology, the water atomizing cup in the present disclosure avoids the use of the straw in the traditional water atomizing cup, not only improves the flexibility of the cup body, making the design of the cup body be more free and movable and the entire cup lid be suitable for various cup bodies, but also solves the problem of the reduced atomization effect caused by the wear or blockage of the straw, and at the same time ensures the stable transmission of water flow in a manner that the water pump is disposed in the lid body, the bottom of the lid body is hermetically connected with the water supply ring, and the water outlet tap of the water pump communicates with the atomization nozzle through the atomization seat while the water inlet tap of the water pump is in butt joint communication with the water supply hole of the water supply ring through the water supply seat, to form a complete water mist generation system.

### BRIEF DESCRIPTION OF THE DRAWINGS

FIG. 1 is a perspective enlarged view of a cup lid according to the present disclosure;

FIG. 2 is another perspective enlarged view of a cup lid according to the present disclosure;

FIG. 3 is a perspective exploded view of a cup lid according to the present disclosure;

FIG. 4 is an enlarged view of portion A in FIG. 3;

FIG. 5 is another perspective exploded view of a cup lid according to the present disclosure;

FIG. 6 is an enlarged view of portion B in FIG. 5;

FIG. 7 is an enlarged perspective assembly view of a lid body, a water supply seat and an atomization seat according to the present disclosure;

FIG. 8 is a perspective enlarged view of a water pump, an atomization seat, a water supply seat and a water supply ring according to the present disclosure;

FIG. 9 is an enlarged cross-sectional view of a water pump, an atomization seat, a water supply seat and a water supply ring according to the present disclosure;

FIG. 10 is a perspective exploded enlarged view of a water supply ring according to the present disclosure;

FIG. 11 is another perspective exploded enlarged view of a water supply ring according to the present disclosure;

FIG. 12 is a perspective exploded enlarged view of a water supply seat according to the present disclosure;

FIG. 13 is a perspective exploded enlarged view of an atomization seat according to the present disclosure;

FIG. 14 is an enlarged cross-sectional view of a cup lid according to the present disclosure;

FIG. 15 is an enlarged cross-sectional view of a water atomizing cup according to the present disclosure;

FIG. 16 is an enlarged view of portion C in FIG. 15;

FIG. 17 is an enlarged view of portion D in FIG. 15;

FIG. 18 is an enlarged view of portion E in FIG. 15; and

FIG. 19 is an enlarged perspective cross-sectional view of a cup body according to the present disclosure.

### REFERENCE NUMERALS

1. lid body; 11. lid seat; 111. drinking hole; 112. water pump mounting slot; 113. connecting pipe; 114. engagement slot; 12. housing; 121. air inlet valve; 2. lid shell; 21. drinking spout; 22. drinking lid; 221. sealing loop; 23. handle; 231. collar; 232. connecting portion; 233. air inlet hole; 234. positioning protrusion;

235. air valve mounting hole; 24. drinking pipe; 241. sealing gasket; 25. socket; 251. positioning groove; 3. atomization seat; 31. seat body; 311. plug hole; 312. neck; 32. connector clip; 321. buckle; 33. atomization nozzle; 34. atomization joint; 4. water pump; 41. upper shockproof sleeve; 42. lower shockproof sleeve; 43. water outlet tap; 44. water inlet tap; 5. battery; 51. circuit board; 511. button; 512. power switch; 6. water supply ring; 61. water supply loop; 611. upper water supply tank; 612. upper hole; 613. positioning table; 62. sealing ring; 621. positioning slot; 622. limiting slot; 623. lower water supply tank; 624. lower hole; 63. water supply hole; 7. cup lid; 8. water supply seat; 81. water supply body; 811. water supply channel; 812. top post; 82. bottom plug; 83. water supply joint; 84. filtering cotton plug; 9. cup body; 91. inner container; 911. water inlet hole; 92. outer shell; 93. negative pressure space; 931. water storage bin; 94. water outlet hole.

### DETAILED DESCRIPTION

The embodiments of the present disclosure are set forth in detail below with reference to the accompanying drawings, which are for reference and illustration only and do not constitute a limitation to the scope of patent protection of the present disclosure.

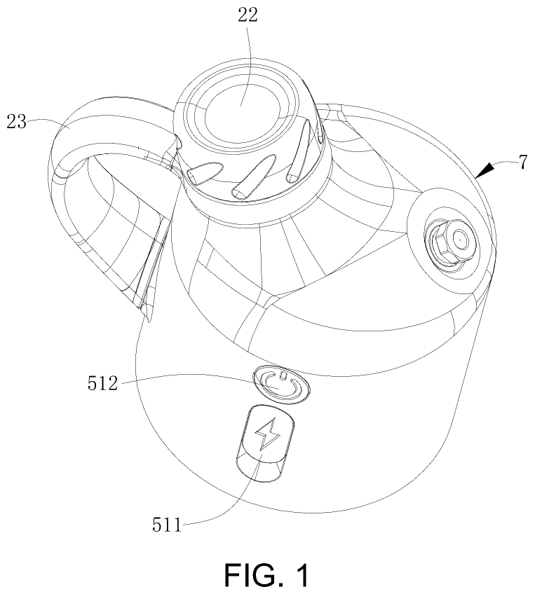

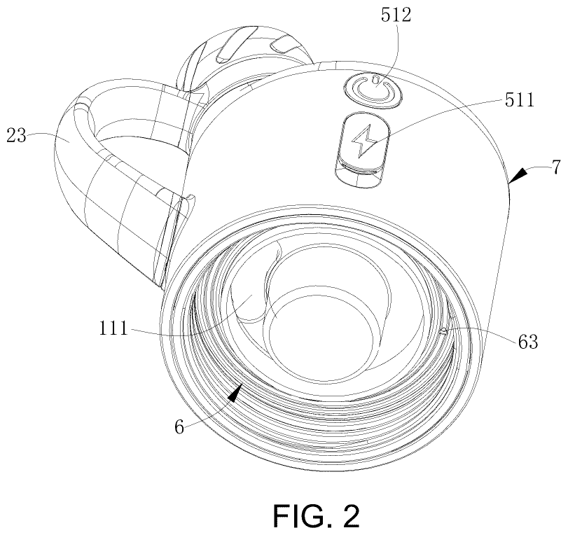

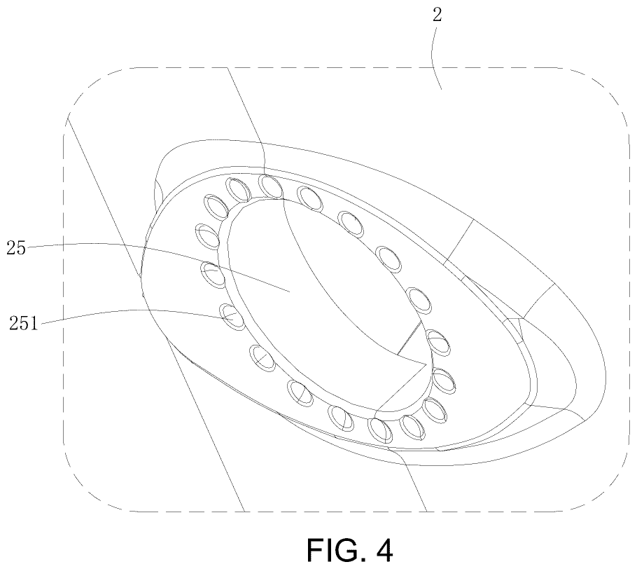

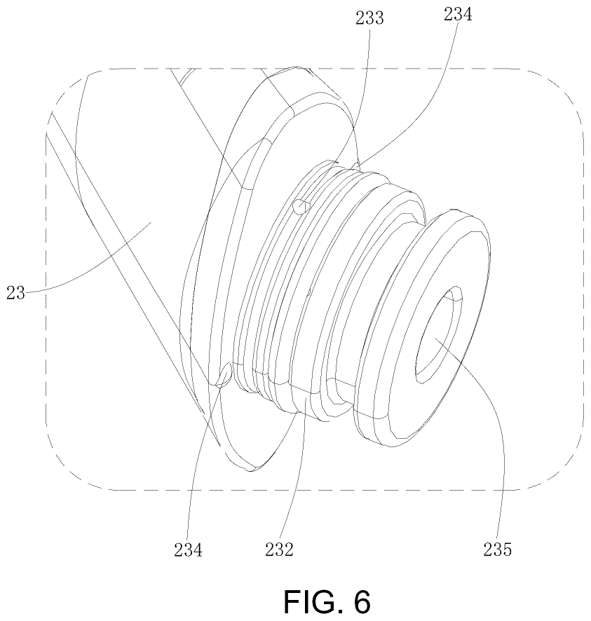

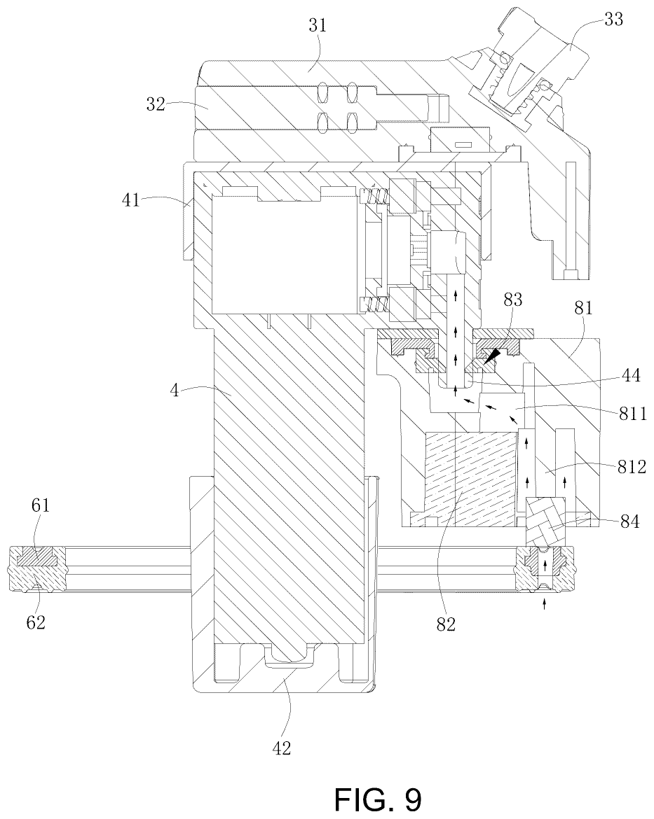

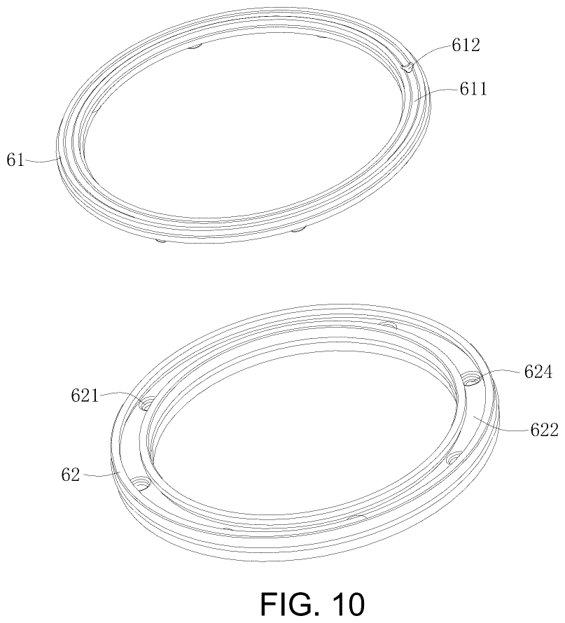

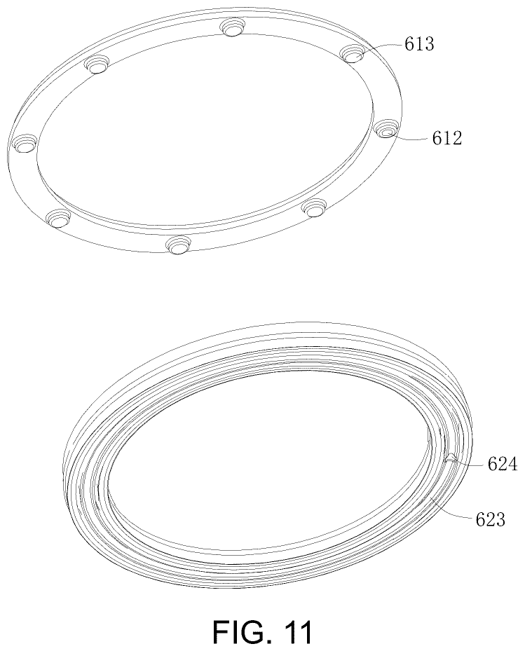

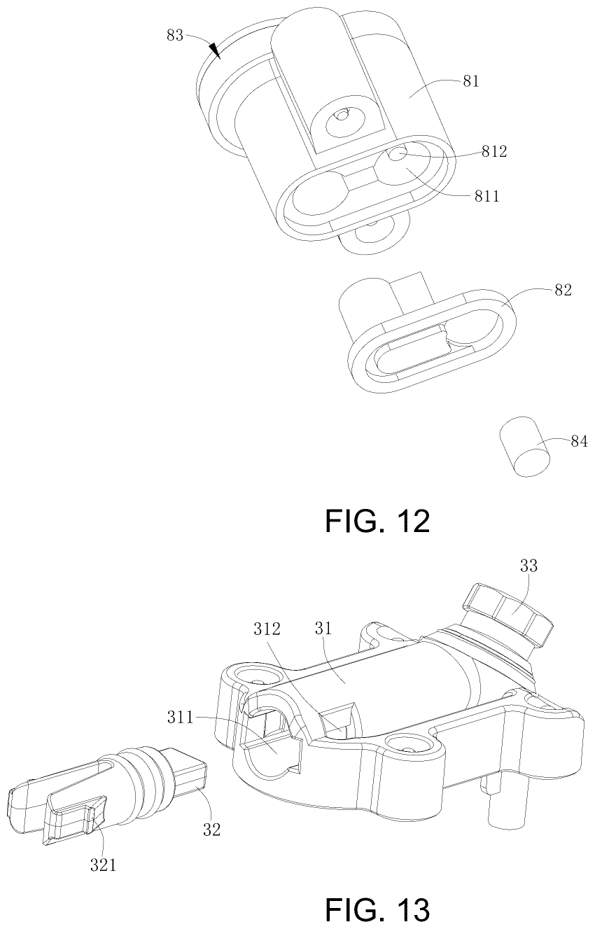

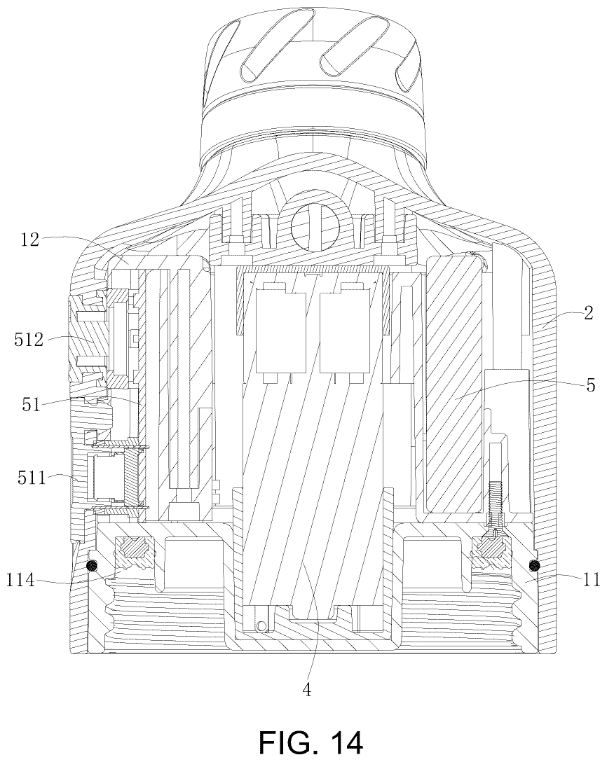

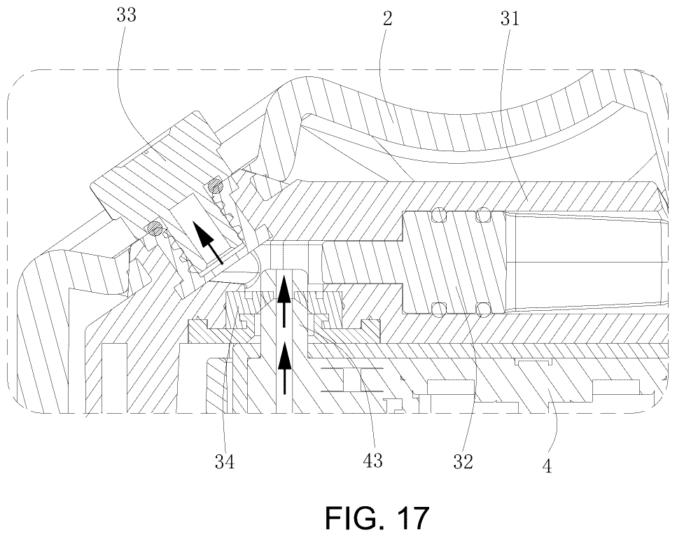

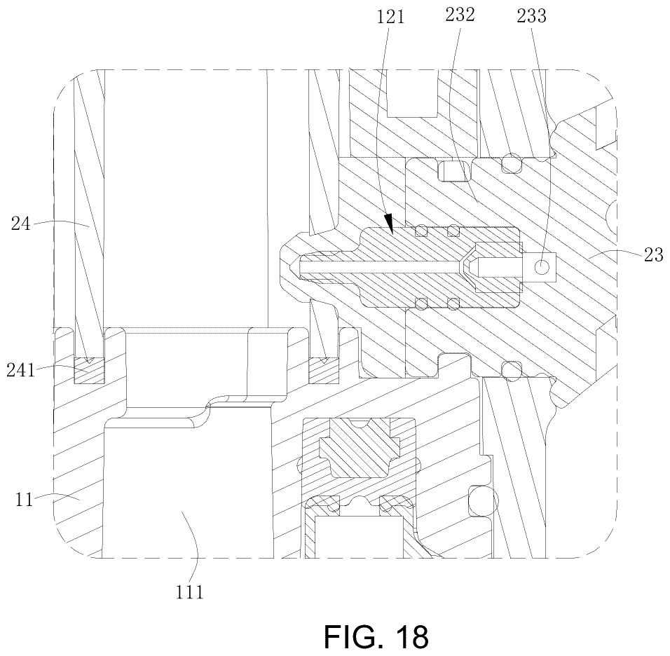

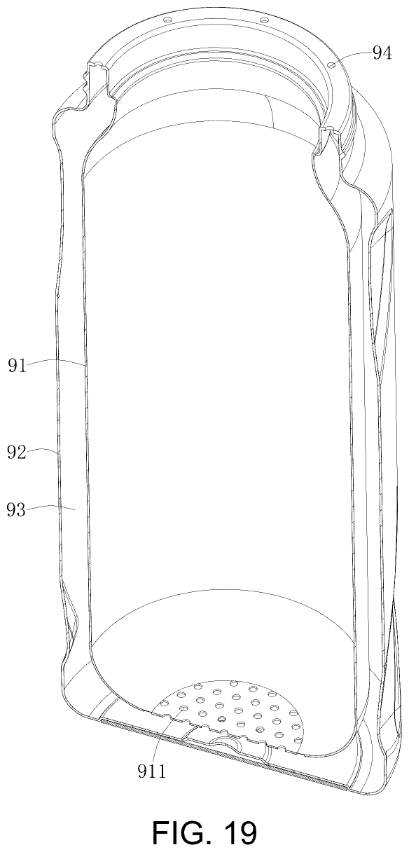

Referring to FIGS. 1 to 19, a water atomizing cup includes a cup lid 7 and a cup body 9, and the cup lid 7 is covered on the cup body 9.

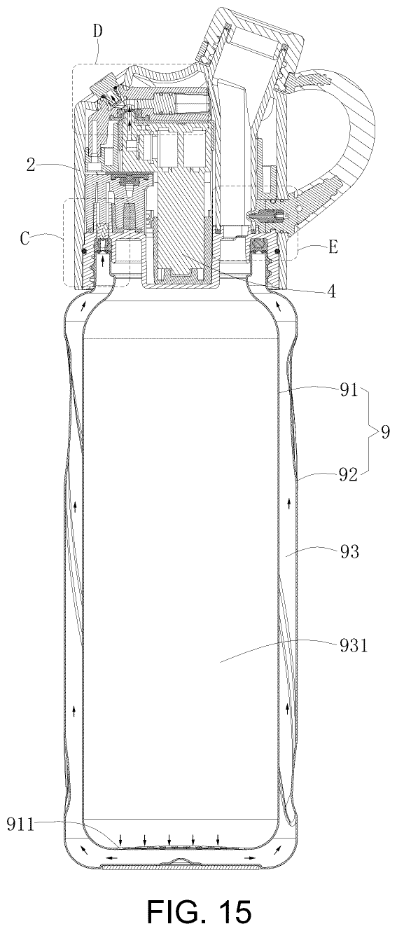

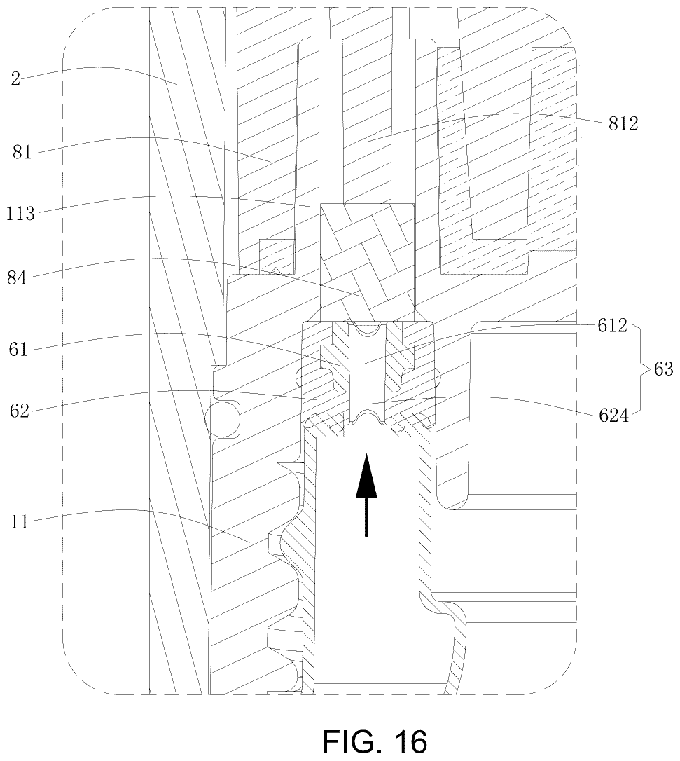

Referring to FIGS. 15, 16 and 19, a top of the cup body 9 is hollow, the cup body 9 includes an inner container 91 and an outer shell 92, the inner container 91 and the outer shell 92 are both cup-shaped, the inner container 91 is positioned in the outer shell 92, a plurality of water inlet holes 911 are disposed at the bottom of the inner container 91, the entire outer shell 92 is spaced apart from the entire inner container 91 to form a negative pressure space 93, the negative pressure space 93 is disposed around the bottom and side walls of the inner container 91, a water storage bin 931 in the inner container 91 communicates with the negative pressure space 93 through all of the water inlet holes 911, a top of the inner container 91 is integrally welded with a top of the outer shell 92 together, a plurality of water outlet holes 94 are disposed at an opening edge of the top of the cup body 9, and all of the water inlet holes 911 communicate with all of the water outlet holes 94 through the negative pressure space 93.

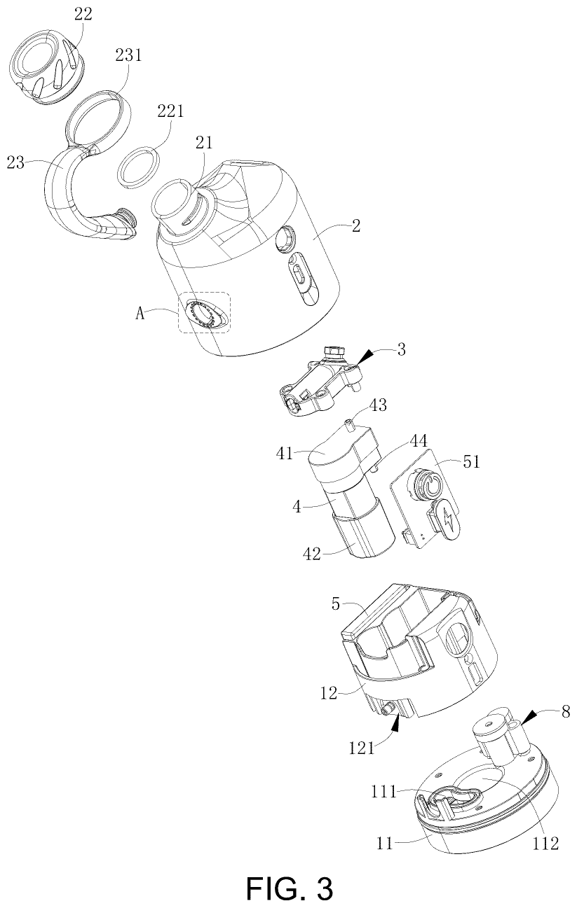

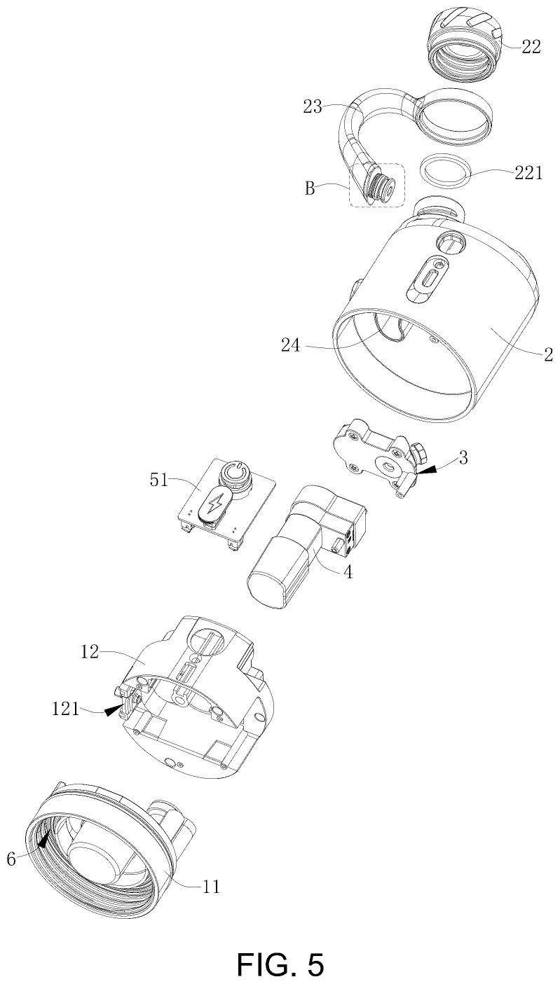

Referring to FIGS. 3 and 5, the cup lid 7 includes a lid body 1, a water pump 4, an atomization seat 3, a water supply seat 8, a lid shell 2 and a water supply ring 6, the water pump 4 is disposed in the lid body 1, the atomization seat 3 is disposed at a top of the water pump 4, an atomizing nozzle 33 is mounted on the atomization seat 3, a water outlet tap 43 of the water pump 4 communicates with the atomization nozzle 33 through the atomization seat 3, the water supply seat 8 is disposed on a side of the water pump 4, the water supply ring 6 is hermetically disclosed at a bottom of the lid body 1, a water supply hole 63 in which water in the cup body 9 enters is disposed on the water supply ring 6, a water inlet tap 44 of the water pump 4 is in butt joint communication with the water supply hole 63 through the water supply seat 8, the lid shell 2 is covered outside the lid body 1, the atomization seat 3 and the water supply seat 8, and a spraying portion of the atomization nozzle 33 is exposed on the lid shell 2.

Referring to FIGS. 3, 5, 7 and 14, the lid body 1 includes a housing 12 and a lid seat 11, a bottom of the lid seat 11 is hollow and provided with a circle of annular engagement slot 114, a top surface of the lid seat 11 is provided with a connecting pipe 113, a water pump mounting slot 112 and a drinking hole 111, an inner hole of the connecting pipe 113 passes through the lid seat 11 and is in butt joint communication with the water supply hole 63, a filtering cotton plug 84 is disposed in the connecting pipe 113, the drinking hole 111 passes through the lid seat 11, the water pump mounting slot 112 is positioned between the drinking hole 111 and connecting pipe 113, internal threads on an inner wall of the lower end of the lid seat 11 cooperate with external threads of the cup body 9, so that the cup lid 7 is connected with the cup body 9, the housing 12 is superimposed on a top end face of the lid seat 11 to form a control bin, the control bin is internally provided with a circuit board 51, the circuit board 51 is electrically connected with a power switch 512 and a button 511, the atomization nozzle 33 is electrically connected with the circuit board 51, the housing 12 is annular, a battery mounting slot is disposed on the housing 12, a battery 5 is mounted in the battery mounting slot, and the battery 5 is electrically connected with the circuit board 51.

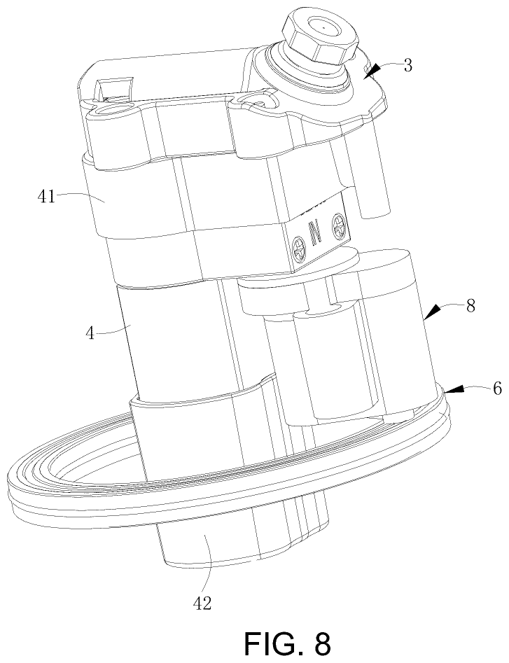

Referring to FIGS. 8, 9, 10, 11, 15 and 16, the water supply hole 63 of the water supply ring 6 communicates with the water outlet holes 94 on the top of the cup body 9, the water supply ring 6 is annular and mounted in the engagement slot 114, the water supply ring 6 includes a water supply loop 61 and a sealing ring 62, both the water supply loop 61 and the sealing ring 62 are annular, a top of the sealing ring 62 is provided with a circle of annular limiting slot 622, a cross section of the limiting slot 622 is T-shaped, a plurality of positioning slots 621 are disposed at a bottom of the limiting slot 622, a circle of annular lower water supply tank 623 is disposed at a bottom of the sealing ring 62, a lower hole 624 is worn on the sealing ring 62, an upper end of the lower hole 624 is positioned in the limiting slot 622 while a lower end of the lower hole 624 is positioned in one of the positioning slots 621, the water supply loop 61 is positioned in the limiting slot 622 at the top of the sealing ring 62, a circle of upper water supply tank 611 is disposed at the top of the water supply loop 61, a cross section of the water supply loop 61 is T-shaped and cooperates with the limiting slot 622 mutually, a plurality of positioning tables 613 are disposed at the bottom of the water supply loop 61 at intervals, all of the positioning tables 613 are disposed in all of the positioning slots 621 in one-to-one correspondence, the positioning tables 613 and the positioning slots 621 constitute a concave-convex limiting structure together, so that the bottom of the water supply loop 61 cooperates with the bottom of the limiting slot 622 through the concave-convex limiting structure, to prevent relative rotation between the water supply loop 61 and the sealing ring 62, an upper hole 612 is worn on the water supply loop 61, and an upper end of the upper hole 612 is positioned in the upper water supply tank 611 while a lower end of the upper hole 612 is positioned in one of the positioning tables 613 (i.e., the upper hole 612 passes through one of the positioning tables 613). In the present disclosure, the upper hole 612 of the water supply loop 61 is in coaxial and butt joint communication with the lower hole 624 of the sealing ring 62 to form the water supply hole 63, and the negative pressure space 93 communicates with an inner hole of the connecting pipe 113 through the plurality of water outlet holes 94, the lower water supply tank 623, the water supply hole 63 and the upper water supply tank 611 in sequence.

Referring to FIGS. 3, 5, 8 and 9, the water pump 4 is specifically an electric pump, the housing 12 is sleeved outside the water pump 4, the water pump 4 is L-shaped and electrically connected with the circuit board 51, the water pump 4 is positioned between the battery 5 and the circuit board 51, a water outlet end of the water pump 4 is provided with a water outlet tap 43 that is positioned at the top of the water pump 4, a water inlet end of the water pump 4 is provided with a water inlet tap 44, upper and lower ends of the water pump 4 are respectively sleeved with an upper shockproof sleeve 41 and a lower shockproof sleeve 42, the water outlet tap 43 passes through the upper shockproof sleeve 41 and extends to the outside of the upper shockproof sleeve 41, the water pump 4 and the lower shockproof sleeve 42 are mounted in the water pump mounting slot 112 together, the water pump 4 passes through the housing 12 from the center of the housing 12, an air inlet valve 121 is mounted on a side wall, close to the drinking hole 111, of the housing 12, and the air inlet valve 121 is specifically a duckbill one-way valve.

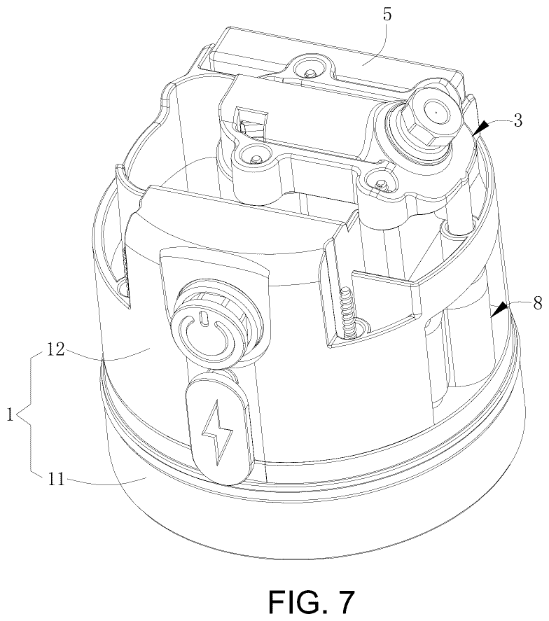

Referring to FIGS. 7, 8 and 9, the water supply seat 8 is mounted at the top of the lid seat 11, exposed on the side wall of the housing 12, and includes a water supply body 81 and a bottom plug 82, the bottom plug 82 is plugged into an opening at the bottom of the water supply body 81 to form a Z-shaped water supply channel 811, an upper end of the water supply channel 811 is a water outlet end thereof while a lower end of the water supply channel 811 is an entry end thereof, the connecting pipe 113 is inserted into the entry end of the water supply channel 811 and is in coaxial communication with the water supply hole 63, a top post 812 is integrally disposed in the entry end of the water supply channel 811, the filtering cotton plug 84 is positioned between the top post 812 and the water supply ring 6, the top post 812 is inserted into the connecting pipe 113 and forms a gap, through which water can pass, with the inner wall of the connecting pipe 113, the water outlet end of the water supply channel 811 is provided with a water supply joint 83, and the water inlet tap 44 of the water pump 4 is hermetically inserted into the water supply joint 83 and clamped with the water supply joint 83.

Referring to FIGS. 7, 8, 9, 13, 15 and 17, the atomization seat 3 is positioned at the top of the water pump 4 and fixed to the housing 12, the atomization seat 3 includes a seat body 31 and a connector clip 32, the atomization nozzle 33 is slantwise mounted at the head of the seat body 31, a plug hole 311 is disposed at a tail of the atomization seat 3, necks 312 are provided on two corresponding sides of the plug hole 311 respectively, the connector clip 32 is hermetically inserted into the tail of the plug hole 311 to prevent the atomization seat 3 from leaking water, buckles 321 are disposed on two corresponding sides of the connector clip 32 respectively, the two buckles 321 are clamped with the two necks 312 one by one, an entrance at the bottom of the seat body 31 communicates with a head space of the plug hole 311, an atomization joint 34 is mounted at the entrance at the bottom of the seat body 31, the water outlet tap 43 of the water pump 4 is hermetically inserted into the atomization joint 34 and clamped with the atomization joint 34, so that the water outlet tap 43 of the water pump 4 can communicate with the atomization nozzle 33 through the head space of the plug hole 311.

Referring to FIGS. 3, 4, 5, 15 and 18, the bottom of the lid shell 2 is hollow, the power switch 512 and the button 511 are both exposed on the side walls of the lid shell 2, a drinking spout 21 is disposed at the top of the lid shell 21, a drinking pipe 24 is integrally disposed in the lid shell 2, the drinking pipe 24 passes through the housing 12 and is hermetically connected with the lid seat 11 through a sealing gasket 241, the drinking pipe 24 is in coaxial and butt joint communication with the drinking hole 111, the drinking spout 21 communicates with a water storage bin 931 of the cup body 9 through the drinking pipe 24 and the drinking hole 111 in sequence, a plurality of hemispherical positioning grooves 251 and a socket 25 are disposed on a side wall of the lid shell 2, and all of the positioning grooves 251 are disposed at intervals in a circle around the socket 25.

Referring to FIGS. 5, 6, 15 and 18, the cup lid 7 further includes a drinking lid 22 and a handle 23, the drinking lid 22 is hermetically covered on the drinking spout 21 of the lid shell 2 through a sealing loop 221, the handle 23 is in a semi-circular shape, the drinking lid 22 is connected with the side of the lid shell 2 through the handle 23, specifically, a collar 231 at an upper end of the handle 23 is sleeved on the drinking lid 22, a lower end of the handle 23 is provided with a connecting portion 232, the connecting portion 232 is inserted into the lid body 1 and the lid shell 2 from the socket 25 and rotationally connected with the lid body 1, an air valve mounting hole 235 is disposed on an end face of the connecting portion 232, the air inlet valve 121 is mounted in the air valve mounting hole 235, an air outlet end of the air inlet valve 121 passes through a side wall of the drinking water pipe 24, an air inlet hole 233 is disposed on a side wall of the connecting portion 232, the air inlet hole 233 communicates with an interior of the air inlet valve 121, a rotating end face of the handle 23 is provided with a plurality of positioning protrusions 234 around the connecting portion 232, two positioning protrusions 234 are preferred in this embodiment, and the two positioning protrusions 234 cooperate with the two positioning grooves 251 so that the handle 23 has a certain hand feel during rotation.

Referring to FIGS. 1 to 19, the working principle of the water atomizing cup in the present disclosure is:

Unscrew the cup lid 7, add a certain amount of water (it can be cold water, normal temperature water, or hot water) into the water storage bin 931 of the cup body 9, discharge the air in the water storage bin 931, cover and tighten the cup lid 7;

After the water pump 4 starts working, negative pressure will generate in the negative pressure space 93 between the inner container 91 and the outer shell 92, the water in the water storage bin 931 enters the negative pressure space 93 through the plurality of water inlet holes 911, the water in the negative pressure space 93 enters the lower water supply tank 623 from the plurality of water outlet holes 94, then enters the upper water supply tank 611 through the water supply hole 63, is filtered by the filtering cotton plug 84, then enters the water supply channel 811 through the gap between the top post 812 and the connecting pipe 113, and then enters the water pump 4 through the water inlet tap 44. The water in the water pump 4 enters the atomization seat 3 from the water outlet tap 43 of the water pump 4 under the action of an impeller, and is finally sprayed out from the spraying portion of the atomization nozzle 33 in a form of water mist;

When needing to drink water, a user can directly unscrew the drinking lid 22 and tilt the entire water cup, and the water in the cup body 9 finally flows out from the drinking spout 21 through the drinking hole 111 and the drinking pipe 24 in sequence;

When the drinking lid 22 and the drinking spout 21 are in a separated state, the user can rotate the handle 23, and the two positioning protrusions 234 on the handle 23 can switch between the plurality of positioning grooves 251, so that the rotation of the handle 23 has a certain hand feel; and

When a certain pressure difference is present between the pressure in the water cup and the outside pressure, gently pull and rotate the handle 23 outward, the air inlet valve 121 is opened, and the outside air can enter the connecting portion 232 through the air inlet hole 233 and the air inlet valve 121 in sequence, to maintain air pressure balance and avoid sluggish water flow caused by air pressure differences.

The water atomizing cup in the present disclosure avoids the use of the straw in the traditional water atomizing cup, not only improves the flexibility of the cup body 9, making the design of the cup body 9 be more free and movable and the entire cup lid 7 be suitable for various cup bodies 9, but also solves the problem of the reduced atomization effect caused by the wear or blockage of the straw, and at the same time ensures the stable transmission of water flow in a manner that the water pump 4 is disposed in the lid body 1, the bottom of the lid body 1 is hermetically connected with the water supply ring 6, and the water outlet tap 43 of the water pump 4 communicates with the atomization nozzle 33 through the atomization seat 3 while the water inlet tap 44 of the water pump 4 is in butt joint communication with the water supply hole 63 of the water supply ring 6 through the water supply seat 8, to form a complete water mist generation system.

The above are only preferred embodiments of the present disclosure and cannot be used to limit the scope of protection of the present disclosure. Therefore, equivalent variations made in the patent scope of the present disclosure still fall within the scope of the present disclosure.

1. A water atomizing cup, comprising a cup lid and a cup body, the cup lid being covered on the cup body, wherein the cup lid comprises a lid body, a water pump is disposed in the lid body, an atomization seat is disposed at a top of the water pump, an atomization nozzle is mounted on the atomization seat, a water outlet tap of the water pump communicates with the atomization nozzle through the atomization seat, a water supply seat is disposed on a side of the water pump, a bottom of the lid body is hermetically connected with a water supply ring, a water supply hole in which water in the cup body enters is disposed on the water supply ring, a water inlet tap of the water pump is in butt joint communication with the water supply hole through the water supply seat, a lid shell is covered outside the lid body, the atomization seat and the water supply seat jointly, and a spraying portion of the atomization nozzle is exposed on the lid shell.

2. The water atomizing cup according to claim 1, wherein the water supply ring comprises a water supply loop and a sealing ring, the water supply loop is positioned in a limiting slot on the top of the sealing ring, and an upper hole of the water supply loop is in coaxial and but joint communication with a lower hole of the sealing ring to form the water supply hole.

3. The water atomizing cup according to claim 2, wherein a circle of upper water supply tank is disposed at a top of the water supply loop, the upper hole is positioned in the upper water supply tank, a circle of lower water supply tank is disposed at a bottom of the sealing ring, the lower hole is positioned in the lower water supply tank, cross sections of both the water supply loop and the limiting slot are T-shaped and cooperate with each other, and a bottom of the water supply loop cooperates with a bottom of the limiting slot through a concave-convex limiting structure.

4. The water atomizing cup according to claim 1, wherein water outlet holes are disposed at a top of the cup body, the water supply hole communicates with the water outlet holes, an inner container of the cup body is spaced apart from an outer shell to form a negative pressure space, water inlet holes are disposed at a bottom of the inner container, and the water inlet holes communicate with the water outlet holes through the negative pressure space.

5. The water atomizing cup according to claim 1, wherein the lid body comprises a housing and a lid seat, the water pump is mounted on the lid seat, the housing is sleeved outside the water pump and superimposed on the lid seat, and the water supply seat is positioned on the lid seat.

6. The water atomizing cup according to claim 5, wherein a water supply channel is disposed in the water supply seat, a connecting pipe is disposed on a top surface of the lid seat, the connecting pipe is inserted into an entry end of the water supply channel and is in coaxial communication with the water supply hole, and a filtering cotton plug is disposed in the connecting pipe.

7. The water atomizing cup according to claim 6, wherein a top post is disposed in the entry end of the water supply channel, the top post is inserted into the connecting pipe and forms a gap with an inner wall of the connecting pipe, and the filtering cotton plug is positioned between the top post and the water supply ring.

8. The water atomizing cup according to claim 1, wherein a drinking hole is disposed in the lid body, a drinking pipe is integrally disposed in the lid shell, a drinking spout on a top of the lid shell communicates with the cup body through the drinking pipe and the drinking hole in sequence, a drinking lid is hermetically covered on the drinking spout, the drinking lid is connected with a side of the lid shell through a handle, and an air inlet valve is disposed on a side wall of the drinking pipe.

9. The water atomizing cup according to claim 8, wherein a connecting portion at a lower end of the handle is inserted into the lid body and the lid shell and rotationally connected with the lid body, the air inlet valve is inserted onto an end face of the connecting portion, an air inlet hole is disposed on a side wall of the connecting portion, and the air inlet hole communicates with an interior of the air inlet valve.

10. The water atomizing cup according to claim 8, wherein a plurality of positioning grooves and a socket into which the connecting portion of the handle is inserted are disposed on a side wall of the lid shell, all of the positioning grooves are disposed at intervals in a circle around the socket, a rotating end surface of the handle is provided with a plurality of positioning protrusions around the connecting portion, and all of the positioning protrusions cooperate with some of the positioning grooves.
